(19) United States
(12) Patent Application Publication
(10) Pub. No.: US 2025/0048404 A1
(43) Pub. Date: Feb. 6, 2025

(54) D2D SCHEDULING METHOD AND APPARATUS IN UAV-BASED IOT NETWORK

(71) Applicant: CHUNG ANG UNIVERSITY INDUSTRY ACADEMIC COOPERATION FOUNDATION, Seoul (KR)

(72) Inventors: Sung Rae CHO, Seongnam-si (KR); Jun Suk OH, Seoul (KR); Dong Hyun LEE, Seoul (KR); Van Dat TUONG, Seoul (KR)

(21) Appl. No.: 18/739,971

(22) Filed: Jun. 11, 2024

(30) Foreign Application Priority Data
Aug. 4, 2023 (KR) 10-2023-0102359

(51) Int. Cl. H04W 72/40; G06V 10/77; G06V 10/82; G06V 20/17; G16Y 10/75; G16Y 40/35; H04L 5/00; H04N 23/61; H04W 72/0446

(52) U.S. Cl. CPC H04W 72/40; G06V 10/7715; G06V 10/82; G06V 20/17; H04L 5/0064; H04N 23/61; H04W 72/0446; G16Y 10/75; G16Y 40/35

(57) ABSTRACT

A D2D scheduling method in a UAV-based IoT network includes: (a) acquiring a geographical map for all transmission links of a D2D network within a network coverage area; (b) applying the geographical map to a sparse convolution model to extract a feature map; (c) defining the feature map for a time slot t as a state Sₜ, and then inputting the feature map to actor and critic networks of a reinforcement learning-based scheduling policy learning model, respectively, and selecting a scheduling decision Aₜ for the D2D transmission link based on a scheduling output of the actor network and a greedy strategy; and (d) transmitting the scheduling decision Aₜ to the D2D network and then receiving reward when the scheduling decision Aₜ is applied by the D2D network, wherein the reward is calculated as a total achievable transmission rate.

### CROSS-REFERENCE TO RELATED APPLICATION

This application claims priority under 35 U.S.C. § 119(a) to Korean Patent Application No. 10-2023-0102359 filed in the Korean Intellectual Property Office on Aug. 4, 2023, the entire contents of which are incorporated herein by reference.

### BACKGROUND

### (a) Technical Field

The present disclosure relates to a D2D scheduling method and apparatus in an unmanned aerial vehicle (UAV)-based Internet of Things (IoT) network.

### (b) Background Art

With the advent of 6G technology, the Industrial Internet of Things (IIoT), which is a network of smart devices, groups of machines, or various sensors connected to the Internet, is becoming important. Due to numerous connections between IIoT devices operating in close proximity in the IIoT network, a machine-type communication is forming a major part of the IIoT as each device is connected to the wireless Internet.

In the case of the 6G IIoT network, which has unique characteristics of the machine-type communication, to provide representative IIoT services such as content distribution, sensing and monitoring-based control, collaborative transportation, and process automation vehicle-to-everything (V2X), device-to-device (D2D) communication is included as one of the core technologies.

One of the most urgent problems in the D2D communication over the IIoT network is determining D2D link scheduling that allows maximum information transmission while efficiently sharing spectrum between links within a given area. To solve this problem, several other problems should be solved.

First, the D2D resource scheduling in the IIoT network requires channel state information (CSI) for all links throughout the network. However, there is a problem in that it is difficult to obtain signal and interference channel gains between a D2D transmitter, receiver, and adjacent users because the cardinality of the channel gain is quite high. That is, accurately estimating and collecting the CSI incurs significant cost and resource consumption, and transmitting the CSI to local and global control devices requires significant power and control overhead.

Second, the resource distribution and interference control between D2D transmissions require high computational complexity. Most existing D2D scheduling algorithms for the IIoT network are different. However, to allocate resources, numerous mathematical calculations are performed using all necessary information such as channel and interference status of the network, resulting in significant computational complexity.

### SUMMARY OF THE DISCLOSURE

The present disclosure provides a D2D scheduling method and apparatus in a UAV-based IoT network.

In addition, the present disclosure provides a D2D scheduling method and apparatus in a UAV-based IoT network that enables scheduling of a transmission link of a D2D network without CSI.

In addition, the present disclosure provides a D2D scheduling method and apparatus in a UAV-based IoT network that is fast and has low complexity based on UAV support topology information.

According to an aspect of the present disclosure, a D2D scheduling method in a UAV-based IoT network is provided.

According to an embodiment of the present disclosure, a D2D scheduling method in a UAV-based IoT network includes: (a) acquiring a geographical map for all transmission links of a D2D network within a network coverage area; (b) applying the geographical map to a sparse convolution model to extract a feature map; (c) defining the feature map for a time slot t as a state Sₜ, and then inputting the feature map to actor and critic networks of a reinforcement learning-based scheduling policy learning model, respectively, and selecting a scheduling decision Aₜ for the D2D transmission link based on a scheduling output of the actor network and a greedy strategy; and (d) transmitting the scheduling decision Aₜ to the D2D network and then receiving reward when the scheduling decision Aₜ is applied by the D2D network, wherein the reward is calculated as a total achievable transmission rate.

The total achievable transmission rate may be calculated by the following Equation:

$${R}_{t} = {\sum }_{i = 1}^{N} {w}_{i} {Φ}_{i} ( t )$$

wherein, wᵢ∈(0,1) represents a weight coefficient indicating a preference of the transmission link, and Φᵢ(t) represents the achievable data transmission rate of a transmission link i in a time slot T.

The sparse convolution model may include: a basic block that extracts the feature map from the geographical map through a 3×3 kernel, compresses the feature map through the 3×3 depth-specific kernel, applies 2×2 max pooling, and then applies the 3×3 depth-specific kernel to filter out low-cost features and output the feature map; an expansion block that expands the feature map output through the basic block to extract the differential feature map; and a deep block that groups the differential feature maps output through the expansion block and applies a convolution layer to generate independent feature maps, and then applies a pointwise convolution layer to linearly combine the independent feature maps and outputs a final output feature map through a max pooling layer.

The geographical map may be a grid image including a transmitter and a receiver of each node pair in the D2D network.

The geographical map in step (a) above may be acquired through a camera mounted on the UAV, and acquired whenever a topology change of the geographical map occurs.

Steps (a) to (d) above may be performed on the UAV.

According to another aspect of the present disclosure, a D2D scheduling apparatus in a UAV-based IoT network is provided.

According to another embodiment of the present disclosure, a D2D scheduling apparatus in a UAV-based IoT network includes: a camera that acquires a geographical map for all transmission links of a D2D network within a network coverage area; a preprocessing unit that applies the geographical map to a sparse convolution model to extract a feature map; a scheduling unit that defines the feature map for a time slot t as a state Sₜ, and then inputs the feature map to actor and critic networks of a reinforcement learning-based scheduling policy learning model, respectively, and selects a scheduling decision Aₜ for the D2D transmission link based on a scheduling output of the actor network and a greedy strategy; and a processor that controls to transmit the scheduling decision Aₜ to the D2D network, wherein when the scheduling decision Aₜ is applied by the D2D network, reward is applied to the reinforcement learning-based scheduling policy learning model.

By providing a D2D scheduling method and apparatus in a UAV-based IoT network according to an embodiment of the present disclosure, it is possible to schedule a transmission link of a D2D network that is fast and has low complexity based on UAV support topology information without CSI.

### BRIEF DESCRIPTION OF DRAWINGS

FIG. 1 is a diagram schematically showing a UAV-assisted D2D system according to an embodiment of the present disclosure.

FIG. 2 is a flowchart illustrating a D2D scheduling method according to an embodiment of the present disclosure.

FIG. 3 is a diagram schematically showing a configuration of a sparse convolution model according to an embodiment of the present disclosure.

FIG. 4 is a diagram schematically showing a reinforcement learning-based scheduling policy learning model according to an embodiment of the present disclosure.

FIG. 5 is a graph illustrating achievable transmission rates according to the related art and an embodiment of the present disclosure.

FIG. 6 is a diagram illustrating an achievable data rate according to a change in convolution layer group size according to an embodiment of the present disclosure.

FIG. 7 is a diagram illustrating the achievable transmission rate according to a change in frame size according to an embodiment of the present disclosure.

FIG. 8 is a diagram illustrating achievable data transmission rates corresponding to different link length settings by changing the number of links according to the related art and an embodiment of the present disclosure.

FIG. 9 is a diagram comparing achievable transmission rates according to a network coverage size according to the related art and an embodiment of the present disclosure.

FIG. 10 is a block diagram schematically showing a configuration of a D2D scheduling device in a UAV-based IoT network according to an embodiment of the present disclosure.

### DETAILED DESCRIPTION

In the present specification, singular forms include plural forms unless the context clearly indicates otherwise. In the specification, it is to be noted that the terms “comprising” or “including,” and the like are not be construed as necessarily including several components or several steps described in the specification and some of the above components or steps may not be included or additional components or steps are construed as being further included. In addition, terms “unit,” “module,” and the like, described in the specification refer to a processing unit of at least one function or operation and may be implemented by hardware or software or a combination of hardware and software.

Hereinafter, exemplary embodiments of the present disclosure will be described in detail with reference to the accompanying drawings.

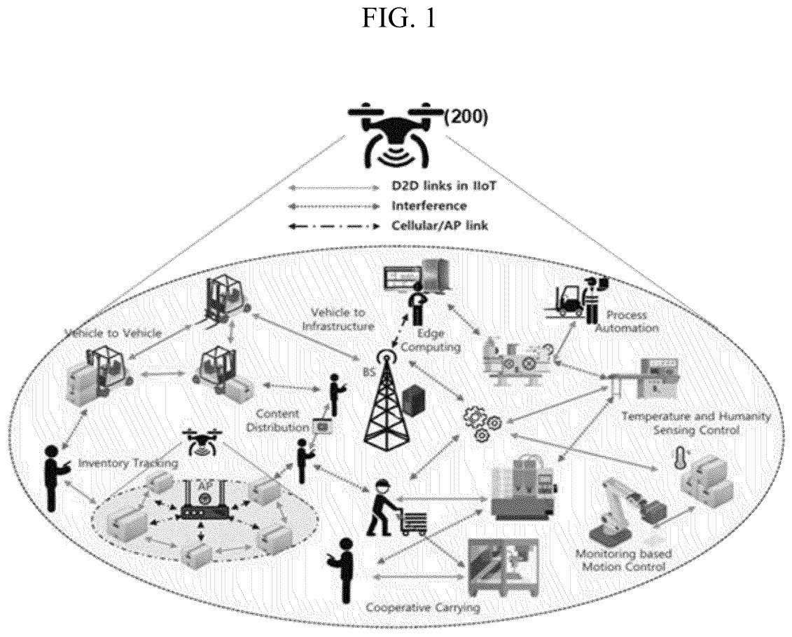

FIG. 1 is a diagram schematically showing a UAV-assisted D2D system according to an embodiment of the present disclosure.

Referring to FIG. 1, a UAV-assisted D2D network system will be briefly described.

One embodiment of the present disclosure focuses on D2D communications and does not consider cellular communications that may exist with an air or terrestrial BS.

A UAV-assisted D2D network system may be composed of N independent D2D links including a transmitter and a receiver, as shown in FIG. 1.

For convenience of understanding and description, the transmitter set is expressed as [symbol] ={1, . . . , N}, and the receiver set is expressed as [symbol] ={1, . . . , N}. It is assumed that a distance between the transmitter and receiver of all links follows a Gaussian distribution, i.i.d (independent and identically distributed).

The UAV-assisted D2D network system will be considered to operate in a time slot manner. Therefore, a scheduling policy x in each time slot is specified as a binary variable {0, 1} and may be expressed as x={xᵢ(t)|i=1, . . . , N,xᵢ(t)∈{0,1}}.

For example, xᵢ(t)=1 indicates that link i is reserved, and xᵢ(t)=0 indicates that link i is not reserved.

The D2D terminal may derive a scheduling decision through a control signal transmitted from the UAV. For example, when link i is activated, the fixed transmission power of the corresponding link is expressed as pᵢ. In addition, a complex channel gain from a transmitter j to a receiver i is expressed as g_{i,j}(t)∈ [symbol] , and the channel gain from the transmitter j to the receiver i is expressed as g_{i,i}(t).

The achievable data transmission rate of the link i in time slot t may be derived as Equation 1 based on the Shannon Equation:

$${Φ}_{i} ( t ) = W {log}_{2} ( 1 + \frac{{\vert {g}_{i , i} \vert}^{2} ( t ) {p}_{i} {x}_{i} ( t )}{{\sum }_{j \neq i} {\vert {g}_{i , j} \vert}^{2} ( t ) {p}_{j} {x}_{j} ( t ) + {σ}^{2}} ) \qquad [ Equation 1 ]$$

wherein, it is assumed that W represents a frequency bandwidth, and may be freely reused in all transmission links. In addition, σ² represents an additive white Gaussian noise (AWGN) power spectral density, which is assumed to be the same for all receivers.

The UAV-assisted D2D network system according to an embodiment of the present disclosure aims to maximize the weighted sum rate of all users in the long term. Since severe inter-link interference reduces the achievable data transmission rate when all the transmission links are activated simultaneously, the wireless scheduling problem may be defined as a subset of links to be activated to maximize a data transmission rate at a given transmission time.

The wireless scheduling that maximizes the weighted sum rate of all users can be expressed as Equation 2:

$${max}_{x} {\sum }_{t = 0}^{T - 1} {\sum }_{i = 1}^{N} {γ}^{t} {w}_{i} {Φ}_{i} ( t ) , \qquad [ Equation 2 ]$$

$$s . t . {x}_{i} ( t ) ∈ \{ 0 , 1 \} , ∀ i = 1 , … , N ,$$

$${Φ}_{i} ( t ) \geq {( {Φ}_{i} )}_{min} , ∀ i = 1 , … , N ,$$

wherein, γ represents a discount rate, and wᵢ∈(0,1) is a weight coefficient representing the preference of the transmission link, and a more preferred link is highly likely to be reserved.

The constraint xᵢ(t)∈{0,1} represents the domain of the scheduling decision, and (Φᵢ)ₘᵢₙ represents the minimum data transmission rate that link i should achieve to ensure the quality of service.

The formulated problem is a discrete optimization that is difficult to solve due to complex scheduling policies, which may induce various interactions between adjacent links, making the inter-link interference unpredictable. The conventional optimization approaches require CSI to solve this problem, but cannot be applied in large-scale wireless D2D networks.

Therefore, in one embodiment of the present disclosure, the UAV may regularly collect geographic information on the network coverage area including the transmitter and receiver locations of the D2D link, and use the collected geographic information to derive the scheduling decision. This will be understood more clearly through the following description.

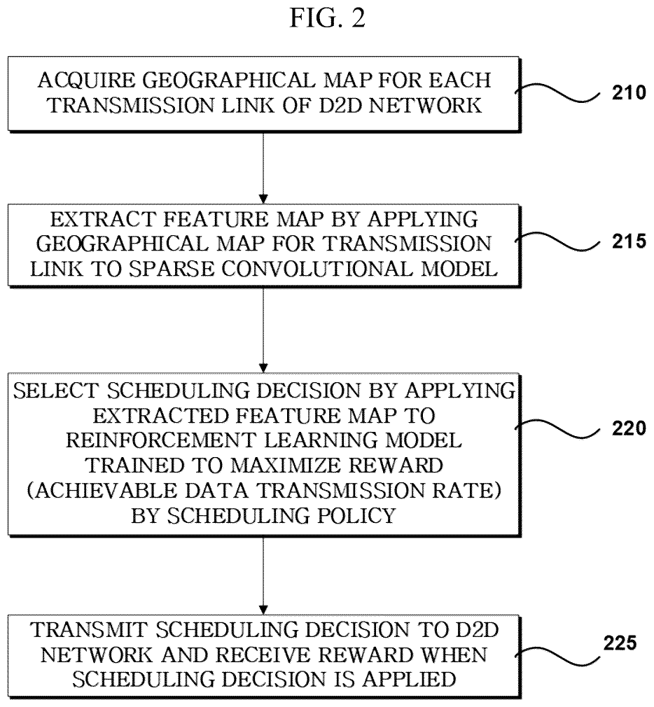

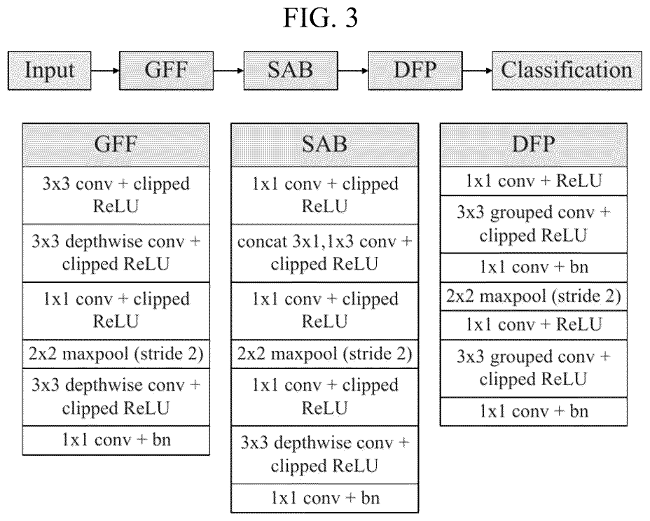

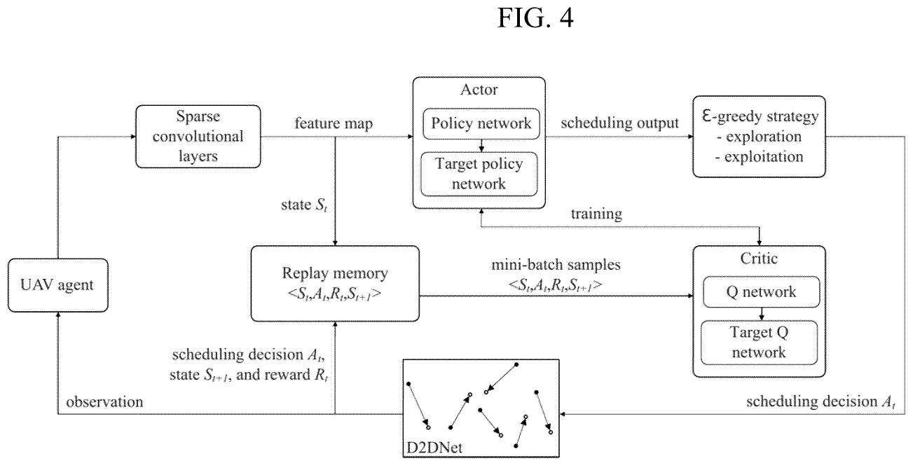

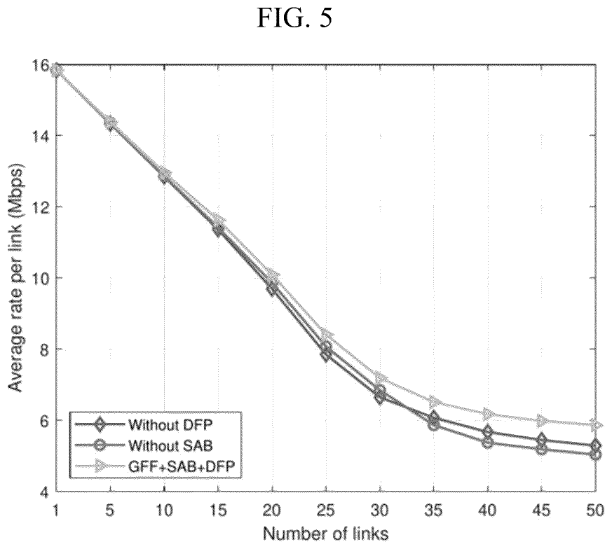

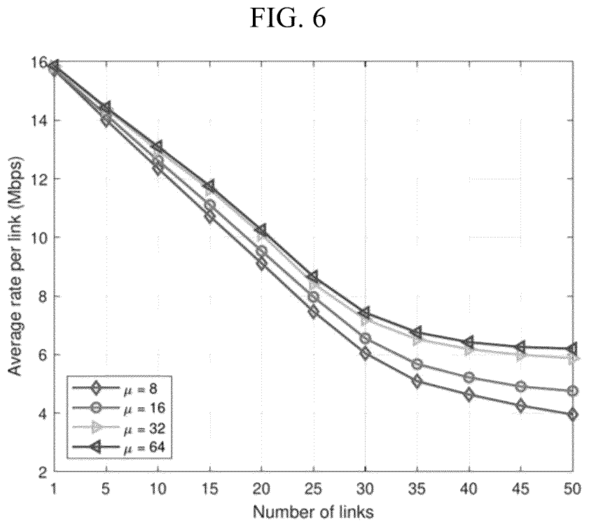

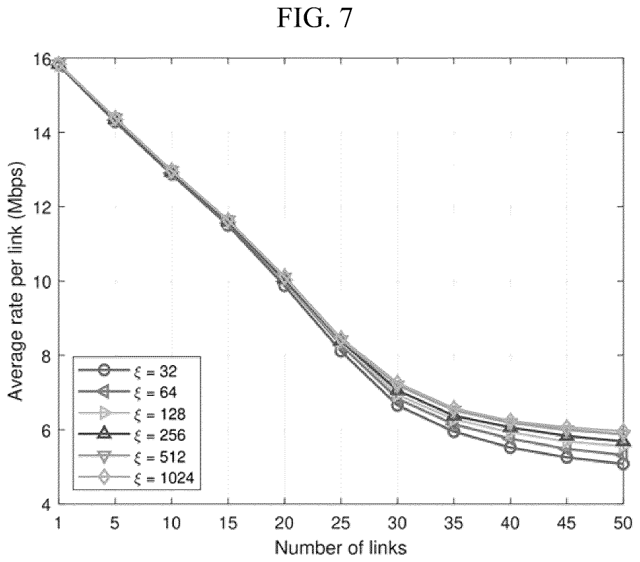

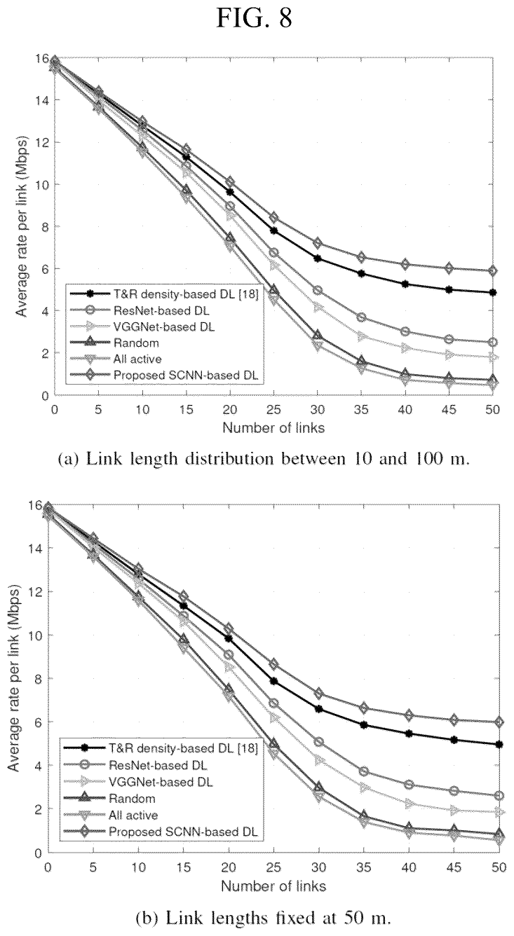

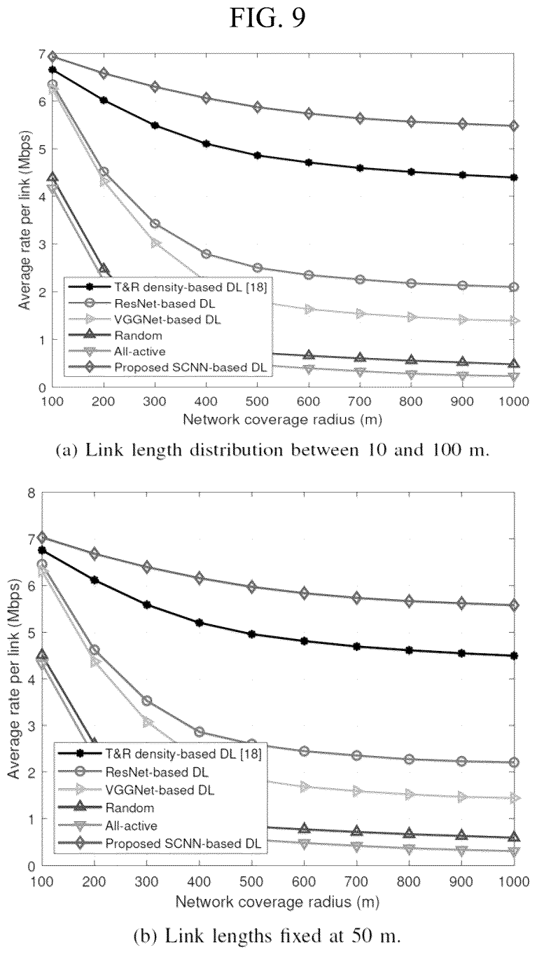

FIG. 2 is a flowchart illustrating a D2D scheduling method according to an embodiment of the present disclosure, FIG. 3 is a diagram schematically showing a configuration of a sparse convolution model according to an embodiment of the present disclosure, FIG. 4 is a diagram schematically showing a reinforcement learning-based scheduling policy learning model according to an embodiment of the present disclosure, FIG. 5 is a graph illustrating achievable transmission rates according to the related art and an embodiment of the present disclosure, FIG. 6 is a diagram illustrating an achievable data rate according to a change in convolution layer group size according to an embodiment of the present disclosure, FIG. 7 is a diagram illustrating the achievable transmission rate according to a change in frame size according to an embodiment of the present disclosure, FIG. 8 is a diagram illustrating achievable data transmission rates corresponding to different link length settings by changing the number of links according to the related art and an embodiment of the present disclosure, and FIG. 9 is a diagram comparing achievable transmission rates according to a network coverage size according to the related art and an embodiment of the present disclosure.

In step 210, a UAV 200 obtains a geographical map for the transmission link.

According to one embodiment of the present disclosure, it is assumed that the UAV is equipped with a camera. Through the camera, the UAV may regularly collect the geographical map for the network coverage area including the transmitter and receiver locations of the D2D link.

It is assumed that the geographical map is prepared for use in the UAV, and it is assumed that each geographical map is a grid image including the transmitter and receiver of each D2D terminal-to-terminal node pair.

In step 215, the UAV 200 applies the geographical map for the transmission link to the sparse convolution model to extract a feature map.

This will be described in more detail below.

The feature map is derived by adding a product of a kernel weight for a spatial location and the corresponding geographical map value based on the geographical map for the transmission link, and may be expressed as a mathematical equation as in Equation 3:

$${v}_{x , y} = {\sum }_{i = 1}^{a} {\sum }_{j = 1}^{b} {ω}_{i , j} {X}_{x + i , y + j} + ϖ \qquad [ Equation 3 ]$$

that is, Equation 3 represents the result of convolution at spatial locations x and y. Here, a×b represents the kernel size, ω_{i,j} represents the kernel weight of i, j, X_{x+i,v+j} represents a matching input map value, and [symbol] represents a bias value added to the convolution result.

Thereafter, a class label may be derived by applying an activation function to [symbol] .

The proposed grouping convolution, which allows deep CNN models to operate on multiple GPUs with limited memory, exhibits higher classification accuracy and lower complexity than the existing CNN model. The grouped convolution may divide depths of input maps of multiple layouts into multiple groups and then perform a convolution operation on each group to derive multiple unrestricted feature maps.

The entire feature map may be derived by connecting independent feature maps in the grouped convolution layer. The filter kernels of all groups have the same size, and the number of filters in each group may vary depending on the neural network model.

In a simple scenario, when the grouped convolution layer has one filter for each group, the performance of the CNN model may be improved by defining it as a depth-specific convolution layer. When there are Ω filter groups, the grouped convolution operation may be calculated as Equation 4:

$${v}_{x , y} = {v}_{x , y , 1} ⊕ … ⊕ {v}_{x , y , ϕ} ⊕ … ⊕ {v}_{x , y , Ω} . \qquad [ Equation 4 ]$$

wherein, ϕ∈[1,Ω], ⊕ represents a concatenation operation,

$${v}_{x , y , ϕ} = {\sum }_{i = 1}^{a} {\sum }_{j = 1}^{b} {ω}_{i , j , ϕ} {X}_{x + i , y + j}$$

represents the convolution result of a group ϕ derived using the kernel weight ω_{i,j,ϕ} at the spatial locations x and y.

As shown in FIG. 3, the detailed structure of the sparse convolution model may be a CNN-based model composed of a basic block (GFF block), an expansion block (SAB block), and a deep block (DFP block).

The basic block is a means for extracting the feature map by performing the convolution operation on the geographical map. As shown in FIG. 3, the basic block is composed of two depth-specific convolution layers, two pointwise convolution layers, one regular convolution layer, and one maximum max pooling layer.

In other words, general features of the geographical map input as the basic block are extracted through a 3×3 kernel, and the extracted features may be compressed through a 3×3 depth-specific kernel. Computational complexity is reduced by passing the pointwise convolution layer, then passing the max pooling layer with 1 and 2 strides, and then, the feature map may be output by additionally filtering the low-cost features through the 3×3 depth-specific kernel following the pointwise convolution layer using batch normalization to reduce the change in internal covariate.

For the basic block, clipped ReLU may be used as an activation function in all the convolution layers except the last pointwise convolution layer.

The feature map output through the basic block is input to the expansion block, and expanded through the expansion block to extract the differential feature map.

The pointwise convolution layer is deployed to expand the feature map input to the expansion block, and the grouped convolution layer with 3×1 and 1×3 asymmetric kernels is used to combine with the pointwise convolution layer to generate an independent feature map.

Thereafter, the independent feature map may be expanded again through the pointwise convolution layer after passing the max pooling layer with 1 or 2 strides to reduce the computational complexity. Next, the differential feature map may be extracted by applying the pointwise convolution layer including a 3×3 depth-specific kernel and the batch normalization.

The expansion block may also use the clipped ReLU as the activation function in all the convolution layers except the last pointwise convolution layer.

The differential feature map extracted from the expansion block is transferred to the deep block, and the information necessary for the CSI estimation may be extracted through the corresponding deep block.

The differential feature map extracted from the expansion block may be transformed using multilayer transformation to reduce the computational cost of the convolution operation. That is, the differential feature map may be processed using the pointwise convolution layer and the 3×3 depth-specific kernel, and then processed using another pointwise convolution layer and the 2×2 max pooling layer with 1, 2 strides to reduce dimensionality and complexity and then transferred to a deep block.

The differential feature map transferred to the deep block is processed using the grouped convolution layer.

In other words, after the differential feature maps transferred to the deep block have features extracted by the pointwise convolution layer, the feature maps may be independently generated using the grouped convolution layer and may again be linearly combined through the pointwise convolution layer. Thereafter, after the computational complexity of linearly combined feature maps is reduced through a max pooling layer with 1 or 2 strides, the differential features may be extracted through the two pointwise convolution layers and the grouped convolution layer and the final feature map may be extracted.

The deeper the deep block layer, the more differential features can be extracted.

In step 220, the UAV 200 selects the scheduling decision by applying the extracted feature map to the reinforcement learning model trained to maximize the data transmission rate achievable by the scheduling policy.

The reinforcement learning-based scheduling policy learning model will be described in more detail with reference to FIG. 4.

The reinforcement learning model for learning the scheduling policy will be described in more detail.

In one embodiment of the present disclosure, a D2D network with N transmission links is assumed. In other words, the reinforcement learning model is composed of a replay memory having a size of S, an actor network, and a critic network. The actor network may be composed of main actor network A and target actor network A′, and the critic network may also be composed of main critic network C and target critic network C′.

The replay memory is initialized as empty, and when the memory is insufficient, the oldest experience may be replaced with the most recent experience.

The weights θ_{A} and θ_{C} of the main actor network and the main critic network are initialized randomly, and may be copied to the weights θ_{A′} and θ_{C′} of the target actor network and the target critic network, respectively.

Since the topology changes in geographical maps may occur frequently, the learning process should be performed on all geographical map inputs to ensure the output scheduling performance. In one embodiment of the present disclosure, it is assumed that all the changes are obtained as the geographical map and may be used to train the reinforcement learning model.

When a new geographical map is acquired by the UAV 200, the reinforcement learning model may be trained regularly. The training process of the reinforcement learning model is composed of several epochs containing time T, and at the beginning of each epoch, the geographical map input of the D2D link may be randomly initialized.

The geographical map for the D2D transmission link is processed by the sparse convolution model to extract the feature map, and the corresponding feature map is input to the actor network and the critic network. In other words, at time slot t, the feature map may be input into the actor network and the critic network in the state Sₜ. The UAV 200 selects scheduling decisions Aₜ for all the D2D links based on the output of the main actor network and the ϵ-greedy strategy.

The ϵ-greedy strategy is a strategy that promotes exploration first and gradually strengthens utilization Aₜ=A(Sₜ;θ_{A}) to improve training speed and convergence.

The exploration probability decreases at a rate of 0.9999, and for utilization, Gaussian white noise or Ornstein-Uhlenbeck noise φₜ may be used to constrain suboptimal scheduling behavior such that the scheduling behavior is derived as Aₜ=A(Sₜ;θ_{A})+φₜ.

In step 225, the UAV 200 transmits the selected scheduling decision (behavior) to the D2D network, and when applied to the D2D network, the UAV 200 may receive reward Rₜ, and the D2D network may advance to the next state Sₜ₊₁.

The step reward may be calculated as the total achievable transmission rate

$${R}_{t} = {\sum }_{i = 1}^{N} {w}_{i} {Φ}_{i} ( t ) .$$

The experience tuple [symbol] Sₜ, Aₜ, Rₜ, Sₜ₊₁ [symbol] generated by executing the policy is stored in a replay memory, and a random mini-batch of experiences is sampled to update the weights of the actor and critic networks.

The loss function may be derived using Equation 5 as the difference between the estimated and target Q-values that are the outputs of the main critic network and the target critic network:

$$L ( {θ}_{C} ) = \frac{1}{Λ} {\sum }_{i = 1}^{Λ} {( {R}_{t , i} + γ {C}^{′} ( {S}_{t + 1 , i} , {A}_{t + 1 , i} ; {θ}_{{C}^{′}} ) - C ( {S}_{t , i} , {A}_{t , i} ; {θ}_{C} ) )}^{2} . \qquad [ Equation 5 ]$$

wherein, Λ represents the size of the mini-bat and [symbol] S_{t,i}, A_{t,i}, R_{t,i}, S_{t+1,i} [symbol] represents an ith experience sample collected at time slot t. To minimize the loss, the Adam optimizer may be used to update the weight coefficients of the main critic network, and may apply a policy gradient as shown in Equation 6 to update the weight coefficients of the main actor network.

$$\begin{matrix}{∇}_{{θ}_{A}} = [ {∇}_{{θ}_{A}} C ( {S}_{t} , {A}_{t} ; {θ}_{C} ) ] \\ = [ {∇}_{{A}_{t}} C ( {S}_{t} , {A}_{t} ; {θ}_{C} ) \times {∇}_{{θ}_{A}} A ( {S}_{t} ; {θ}_{A} ) ]\end{matrix} \qquad [ Equation 6 ]$$

For stability, the weight coefficients of the target network may be gradually updated at every G stage based on a low learning rate η.

FIG. 5 is a graph illustrating the achievable transmission rates according to the related art and an embodiment of the present disclosure. As illustrated in FIG. 5, when the link distribution is dense, the severe inter-link interference occurs, and in the case of the absence of the expansion block or deep block of the present disclosure, it can be seen that the achievable transmission rate decreases more rapidly.

FIG. 6 is a graph illustrating the achievable transmission rate according to the convolution layer group size μ. As illustrated in FIG. 6, it can be seen that as the group size increases, the achievable transmission rate decreases.

FIG. 7 is a graph illustrating the achievable transmission rates according to various frame sizes ξ^{t}, and it can be seen that larger frame sizes provide better achievable transmission rates.

FIG. 8 is a diagram illustrating achievable data transmission rates corresponding to different link length settings by changing the number of links according to the related art and an embodiment of the present disclosure. As illustrated in FIG. 8, since many links cause serious inter-link interference, it can be seen that the average transmission rate per link decreases as the number of links increases. However, as illustrated in FIG. 8, it can be seen that the achievable transmission rate of the D2D scheduling method in a UAV-based IoT network according to an embodiment of the present disclosure is greatly improved compared to the conventional method.

FIG. 9 is a diagram comparing achievable transmission rates according to a network coverage size according to the related art and an embodiment of the present disclosure. As illustrated in FIG. 9, it can be seen that as the network coverage area increases, the achievable transmission rate decreases. It can be seen that compared to the conventional scheduling method, the achievable transmission rate of the scheduling method of the present disclosure is greatly improved as the network coverage area increases.

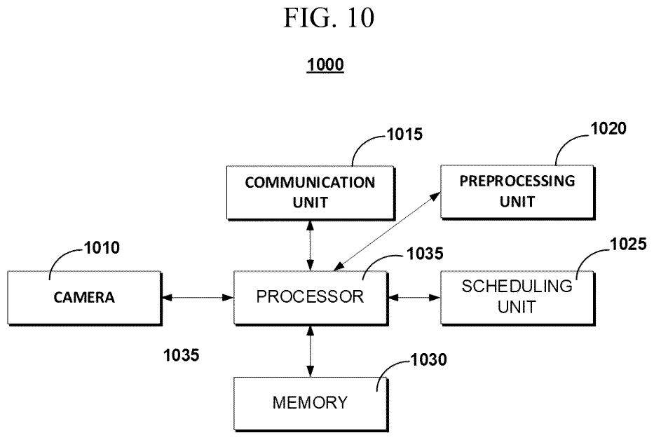

FIG. 10 is a block diagram schematically showing the configuration of a D2D scheduling apparatus in a UAV-based IoT network according to an embodiment of the present disclosure. The D2D network scheduling apparatus may be one configuration of the UAV.

Referring to FIG. 10, the D2D scheduling apparatus in a UAV-based IoT network 1000 according to an embodiment of the present disclosure is configured to include a camera 1010, a communication unit 1015, a preprocessing unit 1020, a scheduling unit 1025, a memory 1030, and a processor 1035.

The camera 1010 is a means for acquiring a geographical map for all transmission links of the D2D network within the network coverage area.

The communication unit 1015 is a means for communicating with the D2D network within the network coverage area.

The preprocessing unit 1020 is a means for applying the geographical map to the sparse convolution model to extract the feature map. As described above, the sparse convolution model is composed of a basic block that extracts the feature map for the geographical map, an expansion block that expands the corresponding feature map, and a deep block that is located at a rear end of the expansion block and extracts a differential feature map for the expanded feature map.

The basic block may extract the feature map from the geographical map through a 3×3 kernel, compress the feature map through the 3×3 depth-specific kernel, apply 2×2 max pooling, and then apply the 3×3 depth-specific kernel to filter out low-cost features and output the feature map.

In addition, the expansion block may be located at the rear end of the basic block, and expand the feature map output through the basic block to extract the differential feature map.

In addition, the deep block may be located at the rear end of the expansion block, and apply the grouped convolution layer to the differential feature maps output through the expansion block to generate the independent feature maps, and then apply the pointwise convolution layer to linearly combine the independent feature maps and output the final output feature map through the max pooling layer.

The scheduling unit 1025 is a means to define the feature map of the time slot t as the state Sₜ, input the feature map to the actor and critic networks of the reinforcement learning-based scheduling policy learning model, respectively, and select the scheduling decision Aₜ of the D2D transmission link based on the scheduling output of the actor network and the greedy strategy. When the corresponding scheduling decision Aₜ is applied by the D2D network, the reward may be applied to the model.

The reinforcement learning-based scheduling policy learning model may be pre-trained.

The memory 1030 stores commands for performing the D2D scheduling method in a UAV-based IoT network according to an embodiment of the present disclosure.

The processor 1035 is a means to control internal components of the D2D scheduling apparatus in a UAV-based IoT network 1000 according to an embodiment of the present disclosure, such as the camera 1010, the communication unit 1015, the preprocessing unit 1020, the scheduling unit 1025, the memory 1030, etc.

In addition, the processor 1035 may control the scheduling decision Aₜ to be transmitted to the D2D network through the communication unit 1015. In addition, the processor 1035 may also control the reward to be applied to the reinforcement learning-based scheduling policy learning model when the scheduling decision Aₜ is applied by the D2D network.

The apparatus and the method according to the embodiment of the present disclosure may be implemented in a form of program commands that may be executed through various computer means and may be recorded in a computer-readable medium. The computer-readable medium may include a program command, a data file, a data structure, or the like, alone or in a combination thereof. The program commands recorded in the computer-readable medium may be specifically designed and constituted for the present disclosure or be known to and used by those skilled in a field of computer software. Examples of the computer-readable recording medium may include magnetic media such as a hard disk, a floppy disk, and a magnetic tape, optical media such as a compact disk read only memory (CD-ROM) or a digital versatile disk (DVD), magneto-optical media such as a floptical disk, and a hardware device specially configured to store and execute program commands such as a ROM, a random access memory (RAM), a flash memory, or the like. Examples of the program commands include a high-level language code capable of being executed by a computer using an interpreter, or the like, as well as a machine language code made by a compiler.

The above-mentioned hardware device may be configured to be operated as one or more software modules in order to perform an operation according to the present disclosure, and vice versa.

Hereinabove, the present disclosure has been described with reference to exemplary embodiments thereof. It will be understood by those skilled in the art to which the present disclosure pertains that the present disclosure may be implemented in a modified form without departing from essential characteristics of the present disclosure. Therefore, the exemplary embodiments disclosed herein should be considered in an illustrative aspect rather than a restrictive aspect. The scope of the present disclosure should be defined by the claims rather than the above-mentioned description, and all differences within the scope equivalent to the claims should be interpreted to fall within the present disclosure.

What is claimed is:

1. A device to device (D2D) scheduling method in an unmanned aerial vehicle (UAV)-based Internet of Things (IoT) network, comprising:
(a) acquiring a geographical map for all transmission links of a D2D network within a network coverage area;
(b) applying the geographical map to a sparse convolution model to extract a feature map;
(c) defining the feature map for a time slot t as a state Sₜ, and then inputting the feature map to actor and critic networks of a reinforcement learning-based scheduling policy learning model, respectively, and selecting a scheduling decision Aₜ for a D2D transmission link based on a scheduling output of the actor network and a greedy strategy; and
(d) transmitting the scheduling decision Aₜ to the D2D network and then receiving reward when the scheduling decision Aₜ is applied by the D2D network,
wherein the reward is calculated as a total achievable transmission rate.

2. The D2D scheduling method of claim 1, wherein the total achievable transmission rate is calculated by the following Equation:
$${R}_{t} = {\sum }_{i = 1}^{N} {w}_{i} {Φ}_{i} ( t )$$
wherein, ωᵢ∈(0,1) represents a weight coefficient indicating a preference of a transmission link, and Φᵢ(t) represents an achievable data transmission rate of a transmission link i in a time slot T.

3. The D2D scheduling method of claim 1, wherein the sparse convolution model includes:
a basic block that extracts the feature map from the geographical map through a 3×3 kernel, compresses the feature map through a 3×3 depth-specific kernel, applies a 2×2 max pooling, and then applies the 3×3 depth-specific kernel to filter out low-cost features and output the feature map;
an expansion block that expands the feature map output through the basic block to extract a differential feature map; and
a deep block that groups the differential feature maps output through the expansion block and applies a convolution layer to generate independent feature maps, and then applies a pointwise convolution layer to linearly combine the independent feature maps and output a final output feature map through a max pooling layer.

4. The D2D scheduling method of claim 1, wherein the geographical map is a grid image including a transmitter and a receiver of each node pair in the D2D network.

5. The D2D scheduling method of claim 1, wherein the geographical map in the step (a) is acquired through a camera mounted on a UAV, and
acquired whenever a topology change of the geographical map occurs.

6. The D2D scheduling method of claim 1, wherein the steps (a) to (d) are performed on the UAV.

7. A non-transitory computer-readable recording medium in which a program code for performing the method according to claim 1 is recorded.

8. A D2D scheduling apparatus in a UAV-based IoT network, comprising:
a camera that acquires a geographical map for all transmission links of a D2D network within a network coverage area;
a preprocessing unit that applies the geographical map to a sparse convolution model to extract a feature map;
a scheduling unit that defines the feature map for a time slot t as a state Sₜ, and then inputs the feature map to actor and critic networks of a reinforcement learning-based scheduling policy learning model, respectively, and selects a scheduling decision Aₜ for the D2D transmission link based on a scheduling output of the actor network and a greedy strategy; and
a processor that controls to transmit the scheduling decision Aₜ to the D2D network,
wherein when the scheduling decision Aₜ is applied by the D2D network, reward is applied to the reinforcement learning-based scheduling policy learning model.

9. The D2D scheduling apparatus of claim 8, wherein the sparse convolution model includes:
a basic block that extracts the feature map from the geographical map through a 3×3 kernel, compresses the feature map through a 3×3 depth-specific kernel, applies 2×2 max pooling, and then applies the 3×3 depth-specific kernel to filter out low-cost features and output the feature map;
an expansion block that expands the feature map output through the basic block to extract a differential feature map; and
a deep block that groups the differential feature maps output through the expansion block and applies a convolution layer to generate independent feature maps, and then applies a pointwise convolution layer to linearly combine the independent feature maps and output a final output feature map through a max pooling layer.

10. The D2D scheduling apparatus of claim 8, wherein the geographical map is a grid image including a transmitter and a receiver of each node pair in the D2D network.
